(19) United States
(12) Patent Application Publication
(10) Pub. No.: US 2010/0299265 A1
(43) Pub. Date: Nov. 25, 2010

(54) METHODS AND SYSTEMS FOR SECURITY AUTHENTICATION AND KEY EXCHANGE

(75) Inventors: Paul Walters, Scottsdale, AZ (US); Ulf Andersson, Linkoping (SE)

Correspondence Address: SNELL & WILMER L.L.P. (Main), 400 EAST VAN BUREN, ONE ARIZONA CENTER, PHOENIX, AZ, 85004-2202, US

(73) Assignee: HYPERCOM CORPORATION, Scottsdale, AZ (US)

(21) Appl. No.: 12/596,127

(22) PCT Filed: Apr. 17, 2008
(86) PCT No.: PCT/US08/60676

§ 371 Date: Jul. 19, 2010

Related U.S. Application Data
(60) Provisional application No. 60/912,368, filed on Apr. 17, 2007.

(51) Int. Cl. H04K 1/00; G06Q 20/00

(52) U.S. Cl. 705/67

(57) ABSTRACT

This is for a payment device that may be constructed from separate modules in a secure fashion such that the aggregation of the modules constitutes an overall secure device without the use of additional covers, cases, or tamper-resistant housings. The methods and system are provided whereby the devices within a modular payment system can exchange data between each-other in a secure fashion. While data encryption is being used elsewhere, the present invention extends the security zone from each secure payment module within a modular device out over the cable to the next device. This allows the user to purchase payment device components, place them as they see fit, and not have to obtain certification on their end product as a POS-A level payment device.

### FIELD OF INVENTION

The present invention relates, generally, to security authentication for electronic payment devices, and more particularly to a secure and modular componentized solution for the security authentication and key exchange for point of sale (POS) terminals.

### BACKGROUND OF THE INVENTION

The size and placement of the major components of a payment terminal including the display, keyboard, card reader, and printer, are dictated by the device into which the payment product is embedded. For example, placing the payment product into a fuel pump dictates different placement and sizing than placing the payment product into a car-wash kiosk, or a fast-food restaurant's drive-through lane. When a payment product supplier builds a product to address one of these markets, the product is not generally suitable for the others.

While a solution for this is to build a series of modules for each of the major components of a payment device, and allow the user to place these modules as best suits their installation, this opens a security problem. The security problem is that the housing into which the modules are placed then becomes a ‘secure’ device needing a security certification. It is desired to create a system where users can avoid having to go through the rigors and cost of obtaining security certifications on their overall device.

### SUMMARY OF THE INVENTION

As described herein, in an exemplary embodiment, the present invention facilitates the transfer of encrypted data between components within a modular electronic payment device. In an exemplary embodiment of the present invention, a modular componentized system for outdoor rugged electronic payment devices is provided.

In accordance with an exemplary embodiment of the present invention, methods and system are provided whereby the devices within a modular payment system can exchange data between each-other in a secure fashion. While data encryption is being used elsewhere, the present invention extends the security zone from each secure payment module within a modular device out over the cable to the next device. This allows the user to purchase payment device components, place them as they see fit, and not have to obtain certification on their end product as a POS-A level payment device.

The present invention provides for an outdoor payment device that may be constructed from separate modules in a secure enough fashion such that the aggregation of the modules constitute an overall secure device without the use of additional covers, cases, or tamper-resistant housings.

### BRIEF DESCRIPTION OF THE DRAWINGS

The accompanying drawings, wherein like numerals depict like elements, illustrate exemplary embodiments of the present invention, and together with the description, serve to explain the principles of the invention. In the drawings:

FIG. 1 illustrates an exemplary embodiment of a modular Point-Of-Sale (POS) terminal configuration;

FIG. 2 illustrates an exemplary embodiment of a synchronization process of POS terminal components;

FIG. 3 illustrates an exemplary embodiment of a protocol transfer key exchange; and

FIG. 4 illustrates an exemplary embodiment of communication layers of a POS terminal.

### DETAILED DESCRIPTION

The detailed description of exemplary embodiments of the invention herein makes reference to the accompanying drawings and tables, which show exemplary embodiments by way of illustration and the best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

The present invention may be described herein in terms of functional block components, screen shots, optional selections and various processing steps. Such functional blocks may be realized by any number of hardware and/or software components configured to perform to specified functions. For example, the present invention may employ various integrated circuit components, (e.g., memory elements, processing elements, logic elements, look-up tables, and the like), which may carry out a variety of functions under the control of one or more microprocessors or other control devices. Similarly, the software elements of the present invention may be implemented with any programming or scripting language such as C, C++, Java, COBOL, assembler, PERL, extensible markup language (XML), JavaCard and MULTOS with the various algorithms being implemented with any combination of data structures, objects, processes, routines or other programming elements. Further, it should be noted that the present invention may employ any number of conventional techniques for data transmission, signaling, data processing, network control, and the like. For a basic introduction on cryptography, review a text written by Bruce Schneier entitled “Applied Cryptography: Protocols, Algorithms, and Source Code in C,” published by John Wiley & Sons (second edition, 1996), herein incorporated by reference.

Where required, the system user may interact with the system via any input device such as, a keypad, keyboard, mouse, kiosk, personal digital assistant, handheld computer (e.g., Palm Pilot®, Blackberry®), cellular phone and/or the like). Similarly, the invention could be used in conjunction with any type of personal computer, network computer, work station, minicomputer, mainframe, or the like running any operating system such as any version of Windows, Windows NT, Windows 2000, Windows 98, Windows 95, MacOS, OS/2, BeOS, Linux, UNIX, Solaris or the like. Moreover, although the invention may frequently be described as being implemented with TCP/IP communications protocol, it should be understood that the invention could also be implemented using SNA, IPX, Appletalk, IPte, NetBIOS, OSI or any number of communications protocols. Moreover, the system contemplates the use, sale, or distribution of any goods, services or information over any network having similar functionality described herein.

For the sake of brevity, conventional data networking, application development and other functional aspects of the system (and components of the individual operating components of the system) may not be described in detail herein. It should be noted that many alternative or additional functional relationships or physical connections may be present in a practical system.

A point of sale (“POS”) terminal according to various embodiments of the present invention includes a magnetic stripe reader, various electronic circuits for processing a financial transaction, an interactive display for presenting and receiving input of transaction information, a keypad including numeric and function keys, and a housing containing the circuits, display and keypad. In addition to or instead of the magnetic stripe reader, the POS terminal may also be used with a smart card reader, a contactless card reader, bar card reader, biometric reader, or other input devices, and thus may provide for a variety of interfaces. Wireless capabilities may also be incorporated into the present invention to promote portability. Other periphery devices for use with the POS terminal may include printers, additional displays, PIN entry pads, alphanumeric keyboards, voice prompt systems, and signature capture devices. The POS terminal may be a stand alone unit or may be integrated into an electronic cash register (“ECR”), vending machine or a self check-out kiosk and the like.

In an exemplary POS transaction, the POS terminal facilitates payments by extracting account information from a user's transaction instrument (e.g., when a user swipes a credit card or inserts a smart card), receiving authentication input, constructing an authorization message, and communicating the authorization message to a host computer to authorize a financial transaction. As used herein, the term “user” includes a consumer, cardholder, merchant, and merchant temporarily in possession of a consumer's transaction card. Cardholder authentication may be accomplished using a PIN number, signature, voice command, biometric input, encrypted transaction instrument data, or any other suitable input. The host computer performs normal authorization procedures and returns one of an authorization and a rejection message. In performing an “on-line” transaction, after the transaction is consummated, the POS terminal communicates the relevant details of the transaction to be stored on the host computer system. While in performing an “off-line” transaction, the terminal may approve or decline based on tables or card date or other data, and later forward transaction data to the payment manager host computer. The POS terminal further communicates with the payment manager host computer to reconcile accounts at the end of a predetermined business cycle (e.g., at the end of each day). Communications between the POS terminal and a host computer may be conducted over any suitable network now known or later developed. As used herein, the term “network” shall include any electronic communications means which incorporates both hardware and software components of such. Exemplary networks or communication channels include a telephone network, an extranet, an intranet, Internet, online communications, satellite communications, off-line communications, wireless communications, transponder communications, local area network (LAN), wide area network (WAN), networked or linked devices, and/or any suitable communication or data input modality.

In accordance with an exemplary embodiment, a POS is assembled in a modular format. The POS may operate in an outdoor setting or an indoor setting; it may be supervised or unsupervised. The exemplary embodiments will focus on outdoor, unsupervised POS terminals, but one skilled in the art will know that the invention is not so limited.

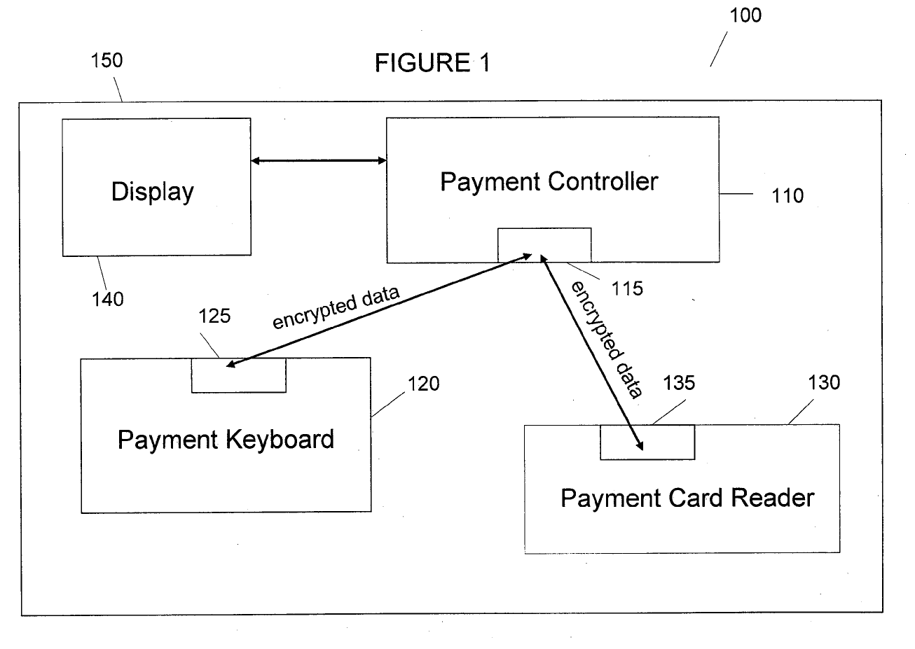

In an exemplary embodiment, and with reference to FIG. 1, an outdoor POS terminal 100 includes a payment controller 110, a payment keyboard 120, a payment card reader 130, and a display 140 located in a housing 150. In another exemplary embodiment, the POS terminal includes the payment controller 110 and a user interface. The user interface includes a display 140 and at least one of the payment keyboard 120, the payment card reader 130, a smart card reader, and a payment contactless reader. In another embodiment, the outdoor POS may include a printer module. All the components of the outdoor POS terminal are contained within the housing 150.

In an exemplary embodiment, the payment controller 110 handles communications with a host system and other components, including a primary user interface. The primary user interface may include a display 140, such as a color screen or a grayscale display, for example a low resolution screen of 160×80. In one embodiment, the payment controller 110 supplies video and sound to a user via the display. Furthermore, in another embodiment, the payment controller 110 communicates external of the outdoor POS terminal and is capable of supporting a variety of communication options. Moreover, in an exemplary embodiment, the payment controller 110 is the primary communications controller for the modular solution of the outdoor POS terminal. This includes communications, self-discovery, and key exchange for encrypted communications between the modules. In addition, in one embodiment, the payment controller is capable of supporting specific combinations of communication ports simultaneously.

In an exemplary embodiment, upon power-up, the payment controller 110 self-discovers which modules are attached to it. This may be done by usage of specific module type codes with communication packets, and a module address. The payment controller 110 may query multiple component types looking for a response.

In certain POS terminal configurations, there may be multiple instances of the same component type with a housing/customer kiosk. In one embodiment, the self-discovery process takes these potential occurrences into account. In an exemplary embodiment, each component will choose a random interval of time to wait prior to responding to a self-discovery request. For example, the different components may choose a random number of milliseconds in multiples of five from 0 too 100 to wait prior to responding to the discovery request.

In the event of a garbled self-discovery response, in an exemplary embodiment, the payment controller 110 will assume a transmission collision occurred between multiple components and reissue the discovery response. In another embodiment, if the payment controller 110 receives multiple garbled self-discovery responses in succession, the payment controller may assume there is a system error and report the error to the host system and/or to the display.

In an exemplary embodiment, the payment controller 110 includes an encryption sub-component 115. In an exemplary embodiment, the encryption sub-component 115 may be hardware or software. Furthermore, in an exemplary embodiment, the encryption sub-component is configured to encrypt and decrypt financial data which is transmitted within the POS terminal, thereby making the financial data transmissions secure within the POS terminal in addition to transmissions to a host system. Further detail regarding the encryption of data is contained below. In an exemplary embodiment, the POS terminal components that receive, transmit, and/or handle financial data each include a separate encryption sub-component. For example, the payment keyboard 125 includes an encryption sub-component 125 and the payment card reader 130 separately includes an encryption sub-component 135. As used herein, the term “financial data” includes account data, credit card data, debit card information, expiration dates, security codes, transaction data, POS terminal related data, user data, merchant data, payment device data, and payment device issuer data.

In accordance with an exemplary embodiment, the payment keyboard 120 is a secure PIN entry device (PED) certified for PCI-PED, ZKA, and INTERAC. The payment keyboard is capable of secure PIN and clear-text numeric data entry. In one embodiment, the payment keyboard is controlled by the payment controller. In another embodiment, the payment keyboard is a “master” when the POS terminal consists of a payment keyboard plus a payment card reader in an outdoor payment product (OPP) environment. In an exemplary embodiment, a security module is included in the payment keyboard. One configuration of the payment keyboard has the security module built into a plastic cover and fitted at the back of the keyboard. In an exemplary embodiment, the payment keyboard is suitable for an outdoor environment and rugged enough to be environmentally resistant. For example, the payment keyboard may be a Storm Interface SF8000 keypad or a Dewhurst Unipad 16 keypad. Moreover, payment keyboard may be any suitable keyboard as would be known to one skilled in the art.

In an exemplary embodiment, the payment card reader 130 accepts magnetic stripe cards and reads them. In one embodiment, payment card reader is a magnetic stripe reader (MSR)-only version. In another embodiment, the payment card reader is an MSR plus EMV hybrid version (i.e., chip or pin). For example, the payment card reader may be based on the H2210. In one embodiment, the payment card reader acts as a slave to the payment controller and/or the payment keyboard. Moreover, payment card reader may be any suitable card reader as would be known to one skilled in the art.

In accordance with an exemplary embodiment, the payment contactless reader utilizes radio frequency (RF) technology to receive transaction data. In an exemplary embodiment, the payment contactless reader allows reading of ISO14443A+B and ISO15963 cards. In one embodiment, for example, the payment contactless reader will support Amex Expresspay, MC PayPass, Visa Contactless. Furthermore, in an exemplary embodiment, the payment contactless reader will read ISO15963 transit cards such as the ‘Oyster’ and MiFare based cards. Moreover, payment contactless reader may be any suitable contactless reader as would be known to one skilled in the art.

In an exemplary embodiment, the payment controller base unit will support base communications. Additionally, the payment controller includes a modular communications option, resulting in additional communication methods to be added. In an exemplary embodiment, the data-layer will use protocol of FPE32 as that is what the payment controller may be. The link-layer protocol may be any protocol appropriate for the physical layer. For example, TCP/IP for an 802.3 physical layer. In addition, payment contractless reader may support any suitable contactless protocols as would be known to one skilled in the art.

Some of the communication ports in an exemplary embodiment of the POS terminal include serial (RS232), Ethernet, USB Client, Host USB, and Radio Communications. In one embodiment, the communication ports are serial. For example, a single locking Mini-DIN RS232 port will have the same connector and pinouts as the RS232 port for a POS terminal such as Hypercom's Optimum L4200 POS terminal. In an exemplary embodiment, a POS terminal can accept either 12V or 24V power via the RS232 connector. In another exemplary embodiment, the communication ports will include Ethernet. The TCP/IP stack software will be executed by the main processor and will support the following protocols: IP, ARP, TCP, UDP, ICMP, SNMP, DHCP, DNS, SSL, and FTP. In one embodiment, the TCP/IP software interface is a sockets level interface capable of supporting a minimum of eight simultaneously open socket connections, which may include simultaneous SSL connections. In yet another embodiment, the communication ports include radio communications modules. For example, the radio communications may include GSM/GPRS, WiFi, and/or Cirronet's ZigBee radio module.

In an exemplary embodiment, the outdoor POS terminal will include a USB client communication port. The USB port will have a self-locking connector and is capable of accepting a voltage in the range of 6 volts to 30 volts. In another embodiment, the USB port is able to accept a 12 volt and/or a 24 volt power source in order to power the outdoor POS unit. In one embodiment, the USB client port connects to a host USB port using a suitable cable. In an exemplary embodiment, the modular POS terminal uses tamper-detection cables.

In another exemplary embodiment, the outdoor POS terminal includes a Host USB communication port capable of supporting peripherals. The user will be able to insert flash drives and load content onto the payment controller. In one embodiment, the Host USB is V2.0 compatible and supports at least one of a flash drive, WiFi, and a USB hub.

An important aspect of the present invention includes inter-system communications. The payment system aspects include communicating within the payment system between components, encrypting communications, and detecting tampering. In an exemplary embodiment, each modular component of the POS terminal is able to be separately certified. In another exemplary embodiment, the modular components of the POS terminal which handle financial data are individually certified for secure financial transactions. Since communications between the modular components are encrypted in a sufficient manner, the modular components may be arranged or configured in multiple layouts without the need to recertify the POS terminal as a whole. As can be appreciated, this adds significant freedom to incorporating POS terminals with different housings.

In accordance with an exemplary embodiment, once the self-discovery process is complete, the payment controller is aware of all attached components. The payment controller must negotiate the encryption process with the components. A mutual certificate exchange will take place between the payment controller and a component for mutual authentication. In this exemplary embodiment, the payment controller will select a random 3DES key, encrypt it with the public key of the component, and transmit the resultant cryptogram. The component will decrypt the cryptogram with a private key and use this decrypted 3DES key for all subsequent communications.

In an exemplary embodiment, each component of the outdoor POS may have a USB client port and connect to the payment controller's USB Host ports. Furthermore, the inter-system communications should be encrypted with a minimum strength of 3DES for peripheral component interconnect (PCI) and general security concerns. Also, the outdoor POS terminal should be able to detect if tampering occurs, for example if a cable is cut or removed.

In accordance with an exemplary embodiment, the outdoor POS terminal components perform a mutual certificate exchange for mutual authentication. After mutually authentication, a component, for example a keypad or reader, will select a random 3DES key, encrypt it with the public key of the payment controller, and transmit the resulting cryptogram. The payment controller receives the cryptogram and will decrypt the 3DES key with a private key, and then use this 3DES key for all subsequent communications. The application layer data bytes transmitted between the payment controller and another component are encrypted using the negotiated 3DES key.

Various methods of encryption may be implemented for encrypting the data streams. In an exemplary embodiment, a DES encryption algorithm is used to encrypt and decrypt a single 8-byte block of data. In another embodiment, an Electronic Code Book (ECB) mode of DES stream handling is used and encrypts each successive 8-byte block of data with a single non-changing key. In this method, each 8-byte block of data stands alone. One drawback of the ECB mode is identical plaintext blocks encrypt to identical cipher texts blocks and may allow for detection of patterns in the encrypted data.

Another exemplary embodiment may apply Cipher Block Chaining (CBC) for DES stream handling. CBC results from XORing the input to the encryption with the preceding ciphertext block. In the decryption phase, the output of the decryption is XORed with the preceding ciphertext block. This results in strong resilience to pattern recognition attacks on streams of ciphertext because any change in the plaintext is propagated indefinitely through the data stream. A drawback with the CBC mode is a vulnerability to a “modification attack” of the ciphertext. Any single bit error occurring during transmission of a ciphertext block is propagated to the next subsequent block of plaintext. However, the error does not propagate to any further downstream decryptions.

In an exemplary embodiment, a Propagating Cipher Block Chaining (PCBC) mode of encryption is implemented. The PCBC is a variation of the CBC in which any bits changed in the ciphertext propagating through the entire data stream and changing the entire outcome of all further decryptions in the data stream. The ciphertext and the plaintext of a prior block are XORed with the outcome of the block decryption. Advantages of the PCBC include that it is resilient t bit-flip attacks on the ciphertext and it has pattern recognition resilience.

In an exemplary method of using the PCBC mode, two initial vectors, in addition to a 3DES key, are transmitted during the initial exchange between a component and the payment controller. The two initial vectors are two randomly selected 64 bit values. In one embodiment, the two initial vectors are mutated based on the “packet sequence” number.

In an exemplary embodiment, the payment keyboard acts as a Human Interface Device (HID) and communicates with the payment controller over a USB connection.

In another exemplary embodiment, the payment magnetic stripe reader communicates with the payment controller serially, using RS232. In one embodiment, the payment magnetic stripe reader communicates with a base speed of 19.2 Kbaud, 8 data bits, 1 stop bit, and no parity. Moreover, additional configurations may be used as would be known to one skilled in the art.

In accordance with an exemplary embodiment, payment controller synchronizes with the other outdoor POS terminal components. The synchronization may occur at power-up or reset of the terminal, on regularly scheduled times, if the components lose their synchronization, or it may occur as necessary. Furthermore, synchronization may be requested by the payment controller or any peripheral component. In an exemplary embodiment, a synchronization process is used to create a common, random 3DES Protocol Base Key (PBK).

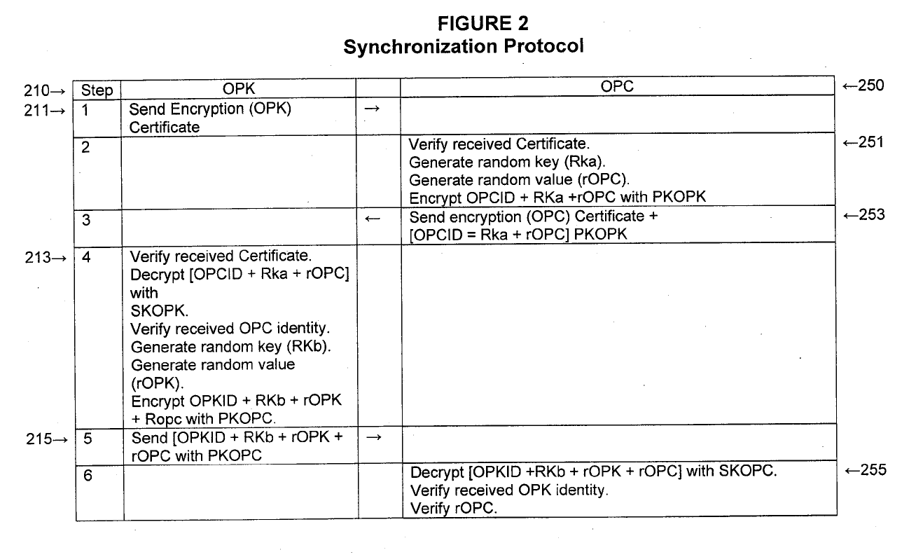

Certificate-based encryption is a system in which a certificate authority uses ID-based cryptography to produce a certificate for authentication. In an exemplary embodiment, and with reference to FIG. 2, the synchronization process for creating a PBK includes the payment keyboard 210 transmits an Encrypting Certificate 211 to the payment controller 250, and the payment controller verifies the Encrypting Certificate. Next, the payment controller generates a random controller key and a random controller value, and encrypts a payment controller identifier, a random controller key, and a random controller value 251. The payment controller transmits the Encryption Certificate, an encrypted random controller key, an encrypted random controller value, and an encrypted payment controller identifier to the payment keyboard 253.

The payment keyboard verifies the received Encryption Certificate and decrypts the received data, creating a decrypted random controller key and a decrypted random controller value. In addition, the payment keyboard generates a random keyboard key and a random keyboard value 213. The payment keyboard then transmits, to the payment controller, a payment keyboard identifier, an encrypted random keyboard key, an encrypted random keyboard value, and an encrypted random controller value 215.

Next, the payment controller decrypts the received data from the payment keyboard, verifies the identity of the payment keyboard and the returned random controller value. If the verification is correct, the PBK is created by XORing the random controller key and the random keyboard key 255. The plain random keyboard value is then transmitted to the payment keyboard 257.

The payment keyboard verifies the plain random keyboard value and creates the PBK by XORing the random controller key and the random keyboard key, thereby creating the same PBK as the payment controller 217.

While the synchronization process for creating a common random 3DES PBK is described herein in terms of a payment keyboard, any peripheral component may be synchronized in the same or similar manner. For example, the invention contemplates the synchronization of a magnetic stripe reader, a smart card reader, various electronic circuits for processing a financial transaction, an interactive display for presenting and receiving input of transaction information, a keypad including numeric and function keys, a contactless card reader, a bar card reader, a biometric reader, printers, additional displays, PIN entry pads, alphanumeric keyboards, voice prompt systems, signature capture devices, and/or any other POS peripherals known in the art.

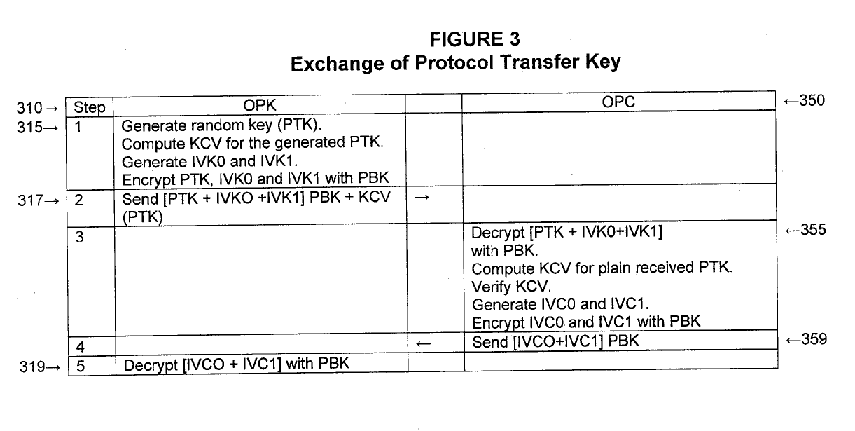

In an exemplary embodiment, and with reference to FIG. 3, the payment controller 350 and the payment keyboard 310 exchange a Protocol Transfer Key (PTK) and Initial Vectors. The payment keyboard 310 generates a random 3DES PTK and two initial keyboard vectors, then encrypts them using the PBK 315, and transmits the encrypted PTK and encrypted initial keyboard vectors to the payment controller 317. The payment controller 350 decrypts the encrypted PTK and encrypted initial keyboard vectors and may store them for future use. Then, the payment controller generates two initial controller vectors, encrypts them using the PBK 355, and transmits the encrypted initial controller vectors to the payment keyboard 359. The payment keyboard decrypts the two encrypted initial controller vectors and may store them for future use in a transfer process 319. All the application layer data bytes transmitted between a payment controller and a payment keyboard will be encrypted using the exchanged PTK and initial vector values. While the exchange of a Protocol Transfer Key (PTK) and Initial Vectors is described herein in terms of a payment keyboard, any peripheral component may be synchronized in the same or similar manner. For example, the invention contemplates the synchronization of a magnetic stripe reader, a smart card reader, various electronic circuits for processing a financial transaction, an interactive display for presenting and receiving input of transaction information, a keypad including numeric and function keys, a contactless card reader, a bar card reader, a biometric reader, printers, additional displays, PIN entry pads, alphanumeric keyboards, voice prompt systems, signature capture devices, and/or any other POS peripherals known in the art.

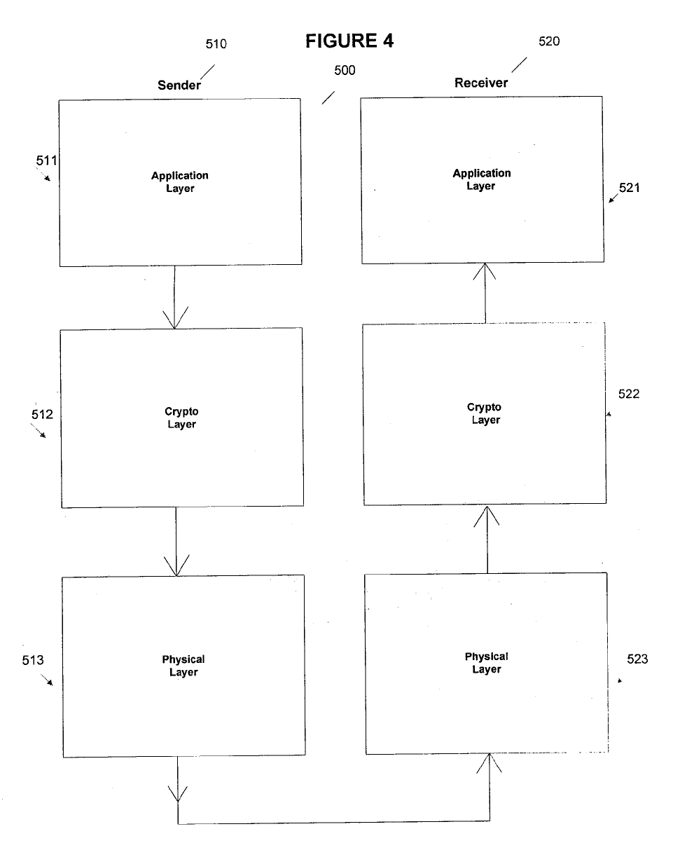

In accordance with an exemplary embodiment, and with reference to FIG. 4, communications are designed with a layer approach such that each layer is only responsible for its own activities. This allows for flexibility in the implementation of each layer. Communications between a sender 410 and a receiver 420 include three layers: an Application layer 411, 421, a Crypto layer 412, 422, and a Physical layer 413, 423. The Application layer 411, 421 may differ for each peripheral and the content of the Application layer is irrelevant to the other layers. In one embodiment, the Application layer transforms and processes transaction data.

In an exemplary embodiment, the Crypto layer 412, 422 handles all authentication, encryption, and decryption of all upper layer data that goes across the communications link. Furthermore, the Crypto layer 412, 422 establishes the encryption keys and secures all data that is transmitted from the Application layers. In an exemplary embodiment, the Physical layer 413, 423 includes the processes and software to transmit encrypted data from the sender 410 to the receiver 420.

In an exemplary embodiment, one aspect of securing the data transmissions between components is to establish the status of the peripherals by polling them. Different actions are taken depending on the component status, including synchronization process, and generating a PTK if the component lacks one. In one embodiment, a component will respond to a poll request with a poll response message. The poll response message may include a device type, a serial number, a key check value for the PBK if valid, a key check value for the PTK if valid, and/or a key check value of the initial vectors if valid.

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

1. A modular Point-Of-Sale (POS) terminal comprising:
a payment controller having a first encryption sub-component;
a display in communication with the payment controller;
a user interface having a second encryption sub-component, the user interface comprising at least one of a payment keyboard and a payment card reader, wherein the user interface is configured to receive financial data; and
wherein the financial data is encrypted prior to transmission in the modular POS terminal, and wherein the modular POS terminal is configured to detect tampering with the modular POS terminal.

2. The modular POS terminal of claim 1, wherein the payment controller and the user interface mutually authenticate using digital certificates.

3. The modular POS terminal of claim 1, wherein the payment controller and the user interface mutually use asymmetric keys and generate a random symmetric key for communications.

4. A method of assembling and using a modular Point-Of-Sale (POS) terminal, the method comprising:
arranging a plurality of components of the modular POS terminal within a housing;
synchronizing the plurality of components of the modular POS terminal;
receiving financial data at a user interface;
encrypting the financial data prior to transmission to a payment controller; and
wherein each component of the plurality of components which handles financial data is certified for financial transactions.

5. The method of claim 4, the synchronizing of the plurality of components of the modular POS terminal further comprising:
transmitting an encrypting certificate from a first module to a second module, wherein the second module verifies the encrypting certificate;
generating a random second module key and a random second module value;
encrypting, at the second module, a second module identifier, the random second module key, and the random second module value;
transmitting, from the second module to the first module, the encryption certificate, the encrypted second module identifier, the encrypted random second module key, and the encrypted random second module value;
verifying the encryption certificate, and decrypting the encrypted second module identifier, the encrypted random second module key, and the encrypted random second module value;
generating a random first module key and a random first module value;
transmitting, from the first module to the second module, a first module identifier, an encrypted random first module key, an encrypted random first module value, and an encrypted random second module value;
creating, at the second module, a protocol base key when the first module is verified, wherein the protocol base key is a combination of the random first module key and the random second module key; and
creating, at the first module, the protocol base key when a received plain random first module key is verified, wherein the protocol base key is a combination of the random first module key and the random second module key.

6. A Point-Of-Sale (POS) terminal configured for secure data transmissions, the POS terminal comprising:
a first module and a second module in communication;
wherein each of the first and second modules are certified for secure financial data transmissions;
a housing containing an assembly of the first and second modules, wherein the assembly is configured to process financial transactions.

7. A method of designing a Point-Of-Sale (POS) terminal layout, the method comprising:
selecting two or more components of a POS terminal, wherein each of the two or more components is certified for financial transactions;
arranging the two or more components within a housing; and
connecting the two or components such that transmission of transaction data is secure, wherein the POS terminal is certified for a financial transaction upon arranging the two or more components.

8. The method of claim 7, wherein the two or more components of a POS terminal comprise at least two of a payment controller, a payment keyboard, a display, a payment card reader, a payment contactless reader, a smart card reader, and a printer module.

9. The method of claim 7, wherein the financial transaction comprises at least one of a credit transaction, a debit transaction, a loyalty point transaction, a reward point transaction, and a preloaded value transaction.

10. A Point-Of-Sale (POS) terminal comprising a first component of the POS terminal, wherein the first component is separately certified for secure financial transactions.
